(19) United States
(12) Patent Application Publication
(10) Pub. No.: US 2025/0376291 A1
(43) Pub. Date: Dec. 11, 2025

(54) PACKING BOX, TONER CONTAINER, AND METHOD OF ASSEMBLING PACKING BOX

(71) Applicants: Teruo SHIBATA, Kanagawa (JP); Tatsuya KUBO, Kanagawa (JP); Seiji TERAZAWA, Kanagawa (JP); Yoshio SANO, Kanagawa (JP)

(72) Inventors: Teruo SHIBATA, Kanagawa (JP); Tatsuya KUBO, Kanagawa (JP); Seiji TERAZAWA, Kanagawa (JP); Yoshio SANO, Kanagawa (JP)

(21) Appl. No.: 19/199,401

(22) Filed: May 6, 2025

(30) Foreign Application Priority Data
Jun. 7, 2024 (JP) 2024-092729

(51) Int. Cl. B65D 5/50; B65D 85/68; G03G 15/08

(52) U.S. Cl. CPC B65D 5/5016; B65D 85/68; G03G 15/0867; B65D 2585/689

(57) ABSTRACT

A packing box includes a polygonal tube extending in a longitudinal direction. The polygonal tube is assembled from a flat plate folded along multiple creases in the longitudinal direction to form multiple edges to pack an object in the polygonal tube. The polygonal tube has holding portions and polygonal rims. The holding portions hold the object. The holding portions project inward in a radial direction orthogonal to the longitudinal direction from positions corresponding to two of the multiple edges at one end of the polygonal tube in the longitudinal direction and two of the multiple edges at another end of the polygonal tube in the longitudinal direction. The polygonal rims have a shifted part in at least a part of the polygonal rims at both ends of the polygonal tube. The shifted part is shifted from an imaginary plane orthogonal to the longitudinal direction.

### CROSS-REFERENCE TO RELATED APPLICATION

This patent application is based on and claims priority pursuant to 35 U.S.C. § 119 (a) to Japanese Patent Application No. 2024-092729, filed on Jun. 7, 2024, in the Japan Patent Office, the entire disclosure of which is hereby incorporated by reference herein.

### BACKGROUND

### Technical Field

The present disclosure relates to a packing box for packing an object such as a toner container, a toner container packed in the packing box, and a method of assembling the packing box.

### Related Art

In the related art, a toner container is detachably attached to an image forming apparatus such as a copier or a printer. The toner container is packed in a packing box as a packed object. The packing box packing the toner container (packed object) is transported from a manufacturing factory to a transportation destination (delivery destination) such as a user.

### SUMMARY

The present disclosure described herein provides an improved packing box including a polygonal tube extending in a longitudinal direction. The polygonal tube is assembled from a flat plate folded along multiple creases in the longitudinal direction to form multiple edges to pack an object in the polygonal tube. The polygonal tube has holding portions and polygonal rims. The holding portions hold the object. The holding portions project inward in a radial direction orthogonal to the longitudinal direction from positions corresponding to two of the multiple edges at one end of the polygonal tube in the longitudinal direction and two of the multiple edges at another end of the polygonal tube in the longitudinal direction. The polygonal rims have a shifted part in at least a part of the polygonal rims at both ends of the polygonal tube. The shifted part is shifted from an imaginary plane orthogonal to the longitudinal direction.

Further, the present disclosure described herein provides an improved packing box including a polygonal tube extending in a longitudinal direction. The polygonal tube is assembled from a flat plate folded along multiple creases in the longitudinal direction to form multiple edges to pack an object in the polygonal tube. The polygonal tube has an inner wall face corrugated in the longitudinal direction to contact the object.

Further, the present disclosure described herein provides an improved method of assembling a packing box. The method includes folding a flat plate along multiple creases to form multiple edges to form a polygonal tube extending in a longitudinal direction to pack an object in the polygonal tube. The flat plate has multiple creases, slits, and ridgelines. The multiple creases extend in the longitudinal direction. The slits extend across the multiple creases in a direction orthogonal to the multiple creases. The ridgelines at both ends of the flat plate in the longitudinal direction to be polygonal rims of the polygonal tube. The polygonal tube has the multiple edges and the polygonal rims. The multiple edges respectively correspond to the multiple creases. The polygonal rims respectively surround openings at both ends of the polygonal tube in the longitudinal direction and have a shifted part in at least a part of the polygonal rims at both ends of the polygonal tube. The shifted part is shifted from an imaginary plane orthogonal to the longitudinal direction. The method further includes making portions between the slits and the polygonal rims in the longitudinal direction project inward in a radial direction orthogonal to the longitudinal direction to form holding portions that hold the object, at positions corresponding to two of the multiple edges at one end in the longitudinal direction and two of the multiple edges at another end in the longitudinal direction.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an overall configuration of an image forming apparatus;

FIGS. 2A and 2B are schematic perspective views of a packing box that packs a toner container;

FIG. 3 is a plan view of a flat plate to be assembled into a packing box;

FIGS. 4A and 4B are perspective views of a packing box, illustrating a part of an operation of assembling the packing box;

FIG. 5A is a cross-sectional view of a packing box packing a toner container taken in a longitudinal direction;

FIG. 5B is a cross-sectional view of the packing box of FIG. 5A as viewed in the direction indicated by arrow A in FIG. 5A;

FIG. 5C is a cross-sectional view of the packing box of FIG. 5A as viewed in the direction indicated by arrow B in FIG. 5A;

FIG. 5D is a cross-sectional view of the packing box of FIG. 5A taken along line C-C in FIG. 5A;

FIG. 6 is a perspective view of a packing box from which a toner container is taken out;

FIG. 7A is a cross-sectional view of a packing box packing a toner container taken in a longitudinal direction according to a first modification;

FIG. 7B is a cross-sectional view of the packing box of FIG. 7A as viewed in the direction indicated by arrow A in FIG. 7A;

FIG. 7C is a cross-sectional view of the packing box of FIG. 7A as viewed in the direction indicated by arrow B in FIG. 7A;

FIGS. 8A and 8B are plan views of a flat plate to be assembled into a packing box according to a second modification;

FIG. 9 is a cross-sectional view of a packing box packing a toner container taken in a longitudinal direction according to a third modification; and

FIG. 10 is a cross-sectional view of a packing box packing toner containers taken in a longitudinal direction according to a fourth modification.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

A package (packing box) according to a comparative example packs a toner container (packed object) therein. A gap between the package (packing box) and the toner container (packed object) is filled with a cushioning material to prevent an impact from propagating to the toner container packed in the package, for example, during transportation. In the comparative example, the package includes the cushioning material to firmly fix the object packed therein.

However, the cushioning material increases the cost and complexity of the packing box. The complexity may hinder the packed object from being taken out from the packing box. Further, if the packing box is freestanding in the longitudinal direction, an impact applied to the packed object may be increased when the packing box accidentally falls down.

Embodiments of the present disclosure are described below in detail with reference to the drawings. In the drawings, like reference signs denote like elements, and overlapping descriptions may be simplified or omitted as appropriate.

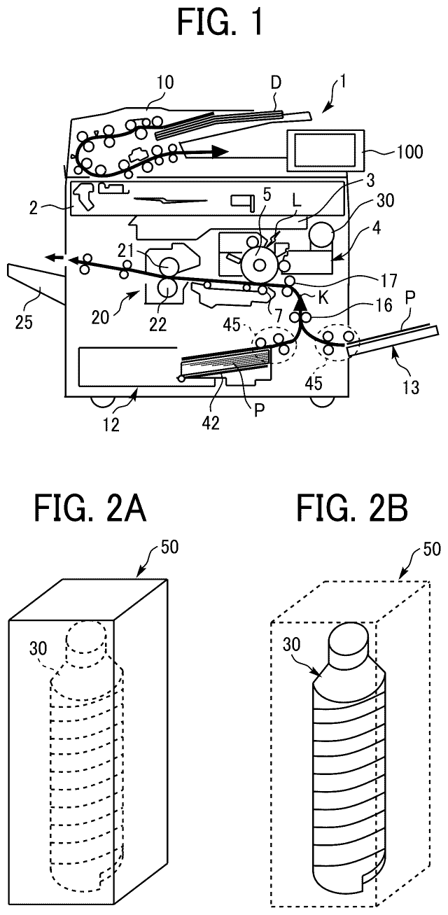

An overall configuration and operation of an image forming apparatus 1 is described below with reference to FIG. 1.

In FIG. 1, the image forming apparatus 1, which is a copier, includes a document reading device 2, an exposure device 3, an image forming device 4, a transfer device 7 serving as an image forming portion, a document feeding device 10, sheet feeding devices 12 and 13, a conveyance roller pair 16, a registration roller pair 17 serving as a timing roller pair, a fixing device 20, and an ejection tray 25. The document reading device 2 optically reads image data of an original document D. The exposure device 3 irradiates a photoconductor drum 5, which is included in the image forming device 4, with exposure light L according to the image data read by the document reading device 2. The image forming device 4 forms a toner image on the photoconductor drum 5. The transfer device 7 transfers the toner image from the photoconductor 5 onto a sheet P.

The document feeding device 10 is an automatic document feeder (ADF) that conveys the original document D placed on a tray to the document reading device 2. Each of the sheet feeding devices 12 and 13 feeds the sheet P accommodated in the corresponding sheet tray. The sheet feeding device 12 is an in-body sheet feeder placed inside the housing of the image forming apparatus 1. The sheet feeding device 13 is a bypass sheet feeder projecting on one side of the housing of the image forming apparatus 1.

The conveyance roller pair 16 is disposed downstream from a sheet feeding assembly 45 in a conveyance direction of the sheet P. The registration roller pair 17 as a timing roller pair conveys the sheet P toward the transfer device 7. The fixing device 20 includes a fixing roller 21 and a pressure roller 22 to fix the toner image borne as an unfixed image on the sheet P. The sheet P is ejected from the housing of the image forming apparatus 1 onto the ejection tray 25. The image forming apparatus 1 further includes a toner container 30 that is detachably (replaceably) attached to the housing of the image forming apparatus 1.

The sheet feeding device 12 includes a sheet stacker 42 (elevation plate) that is vertically movable. Each of the sheet feeding devices 12 and 13 includes the sheet feeding assembly 45 serving as a sheet feeding mechanism. The image forming apparatus 1 further includes an operation display panel 100 for inputting a printing operation to be performed in the image forming apparatus 1 and for displaying the condition of the image forming apparatus 1.

A description is given below of regular image forming operations (printing operations) of the image forming apparatus 1 with reference to FIG. 1.

The original document D is conveyed (fed) by conveyance rollers of the document feeding device 10 from a document loading table in a direction indicated by the arrow in FIG. 1, and then passes over the document reading device 2. At this time, the document reading device 2 optically reads image data of the original document D passing over the document reading device 2.

The image data optically read by the document reading device 2 is converted into electrical signals. The electrical signals are transmitted to the exposure device 3 serving as a writer. The exposure device 3 then emits the exposure light L such as laser light according to the electrical signals (i.e., the image data) toward the surface of the photoconductor drum 5 of the image forming device 4.

Meanwhile, while the photoconductor drum 5 rotates in a clockwise direction in FIG. 1, the image forming device 4 performs a predetermined series of image forming processes, such as a charging process, an exposing process, and a developing process, to form a toner image corresponding to the image data on the surface of the photoconductor drum 5. After the image formation, the toner image formed on the surface of the photoconductor drum 5 is transferred by the transfer device 7, onto the sheet P conveyed by the registration roller pair 17.

The image forming device 4 includes, for example, a charger, a developing device, a cleaner, and a charge neutralizer in addition to the transfer device 7. Fresh toner (new toner) is appropriately supplied from the toner container 30 to the developing device. The toner container 30 has a substantially cylindrical shape. When the toner container 30 runs out of toner, the toner container 30 is replaced with a new toner container 30. The toner container 30 alone is distributed in the market, and is transported from a manufacturing factory to a transportation destination such as a user or a service center. The toner container 30 is packed in a packing box 50 (see FIGS. 2A and 2B) during transportation.

A description is given below of how the sheet Pis conveyed to the transfer device 7 (image forming portion).

One of the sheet feeding devices 12 and 13 included in the image forming apparatus 1 is automatically or manually selected. For example, the sheet feeding device 12 disposed inside the housing of the image forming apparatus 1 is selected. Then, the sheet feeding assembly 45 feeds the uppermost sheet P of the sheets P accommodated in the sheet feeding device 12, toward a sheet conveyance passage K. The sheet P thus fed then passes through the sheet conveyance passage K along which the conveyance roller pair 16 is disposed and reaches the position where the registration roller pair 17 is located. When the sheet P reaches the registration roller pair 17, the registration roller pair 17 is stopped rotating. As the leading end of the sheet P contacts the nip region formed by the rollers of the registration roller pair 17, a skew of the sheet Pis corrected.

Then, the registration roller pair 17 starts rotating again, and the sheet Pis conveyed toward the transfer device 7 (i.e., the image forming portion) in sync with movement of the toner image formed on the surface of the photoconductor drum 5 for forming the toner image on the sheet P at the correct position. The image formed on the surface of the photoconductor drum 5 is transferred onto the sheet P by the transfer device 7. This process is a transfer process.

After the transfer device 7 transfers the toner image from the photoconductor drum 5 onto the sheet P in the transfer process, the sheet P passes the position of the transfer device 7 and reaches the fixing device 20 through the sheet conveyance passage K. In the fixing device 20, the sheet P is conveyed between the fixing roller 21 and the pressure roller 22, so that the toner image is fixed onto the sheet P by application of heat applied by the fixing roller 21 and pressure applied by the fixing roller 21 and the pressure roller 22. This process is a fixing process. After the sheet P bearing the toner image fixed in the fixing process is conveyed out from a fixing nip between the fixing roller 21 and the pressure roller 22, the sheet P is ejected from the housing of the image forming apparatus 1 onto the ejection tray 25 as a sheet having an output image. Thus, a series of the image forming processes (printing operations) is completed.

The packing box 50 for packing a toner container will be described in detail below.

As described above with reference to FIG. 1, the image forming apparatus 1 uses the toner container 30 as a consumable item. The toner container 30 is set in the image forming apparatus 1 when the image forming apparatus 1 starts to be used at a user's site. When the image forming apparatus 1 starts to be used and the toner contained in the toner container 30 runs out, the toner container 30 is removed from the image forming apparatus 1, and a new toner container 30 (filled with toner) is attached to the image forming apparatus 1 instead.

The toner container 30 as a packed object is accommodated (packed) in the packing box 50 as illustrated in FIGS. 2A and 2B before the toner container 30 is set in the image forming apparatus 1. As illustrated in FIG. 2B, a new toner container 30 (packed object) is accommodated in the packing box 50 illustrated in FIG. 2A. The new toner container 30 accommodated in the packing box 50 is transported to a user or stored in a storage place of the user.

When the user starts using the image forming apparatus 1, the user takes out the toner container 30 from the packing box 50 and attaches the toner container 30 to the image forming apparatus 1. In other words, the toner container 30 attached to the image forming apparatus 1 is replaced with the toner container 30 taken out from the packing box 50.

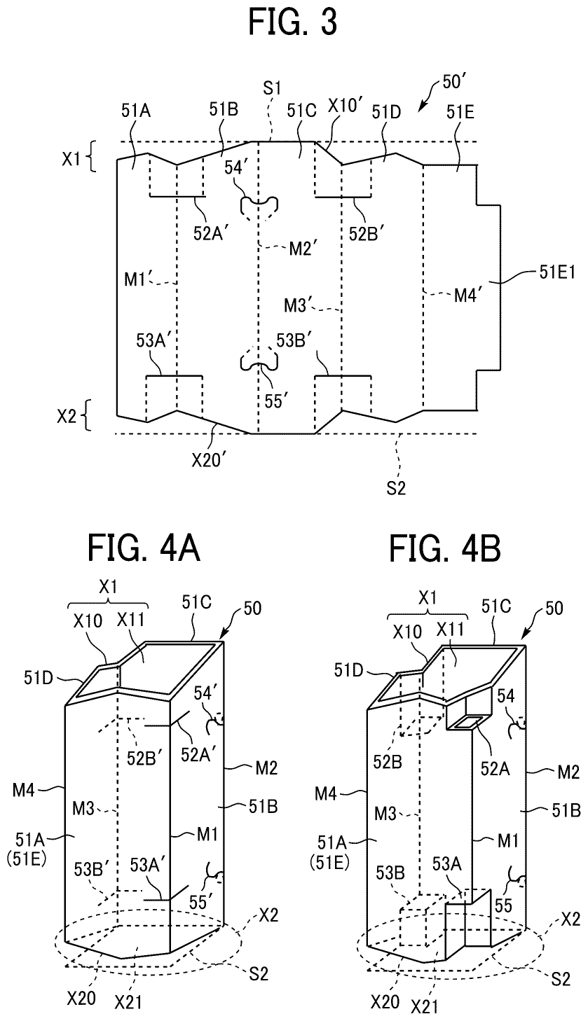

The packing box 50 is formed in a polygonal tube shape (e.g., a square tube shape) so as to pack the toner container 30, which stores toner therein, as a packed object. Creases M1′ to M4′ are put on a flat plate 50′ as illustrated in FIG. 3. The flat plate 50′ is folded along the creases M1′ to M4′ to form a polygonal tube having edges M1 to M4 corresponding to the creases M1′ to M4′ as illustrated in FIGS. 4A and 4B. Specifically, the packing box 50 is made of the rectangular flat plate 50′ made of, for example, corrugated cardboard as a material (raw material). The flat plate 50′ corresponds to a developed view of the packing box 50 as illustrated in FIG. 3.

More specifically, the flat plate 50′ has five substantially rectangular flat faces 51A to 51E partitioned by the four creases M1′ to M4′ parallel to each other. In addition, multiple slits 52A′, 52B′, 53A′, 53B′, 54′, and 55′ are formed in the flat plate 50′. The flat plate 50′ is folded at substantially right angles along the four creases M1′ to M4′ to form the edges M1 to M4, and the flat faces 51A and 51E at both ends are overlaid one on another. Thus, the flat plate 50′ is assembled into the packing box 50 having a square tube shape.

The packing box 50 (and the creases M1′ to M4′ in the flat plate 50′) extends in a longitudinal direction (vertical direction in FIG. 4B). As illustrated in FIG. 4B, the packing box 50 has holding portions 52A, 52B, 53A, and 53B formed at positions corresponding to at least the two edges M1 and M3 among the multiple edges M1 to M4 at one end in the longitudinal direction (upper side in FIG. 4B) and at least the two edges M1 and M3 among the multiple edges M1 to M4 at the other end in the longitudinal direction (lower side in FIG. 4B). Each of the holding portions 52A, 52B, 53A, and 53B projects inward in a radial direction orthogonal to the longitudinal direction to hold the toner container 30 (packed object).

Further, the packing box 50 has end portions X1 and X2 that prevent the packing box 50 from being freestanding in the longitudinal direction (the vertical direction in FIG. 3 and FIGS. 4A and 4B) at both ends in the longitudinal direction, respectively.

With reference to FIGS. 4A and 4B, planes defined by the end faces of the end portions X1 and X2 of the packing box 50 in the longitudinal direction intersect the longitudinal direction but are not orthogonal to the longitudinal direction, in which the edges M1 to M4 extend. When the longitudinal direction of the packing box 50 is aligned with the vertical direction, the end portion X1 corresponds to the top portion of the packing box 50, and the end portion X2 corresponds to the bottom portion of the packing box 50 as illustrated in FIGS. 4A and 4B.

In other words, a method of assembling the packing box 50 includes a first step to fold the flat plate 50′ along the creases M1′ to M4′ to form a polygonal tube having the edges M1 to M4 and a second step to make portions between the slits 52A′, 52B′, 53A′, and 53B′ and the ends of the creases M1′ to M4′ in the longitudinal direction project (pop up) inward in the radial direction to form the holding portions 52A, 52B, 53A, and 53B that hold the toner container 30 (packed object). The slits 52A′, 52B′, 53A′, and 53B′ are formed in a direction (i.e., the left-right direction in FIG. 3) substantially orthogonal to the creases M1′ to M4′ in the flat plate 50′.

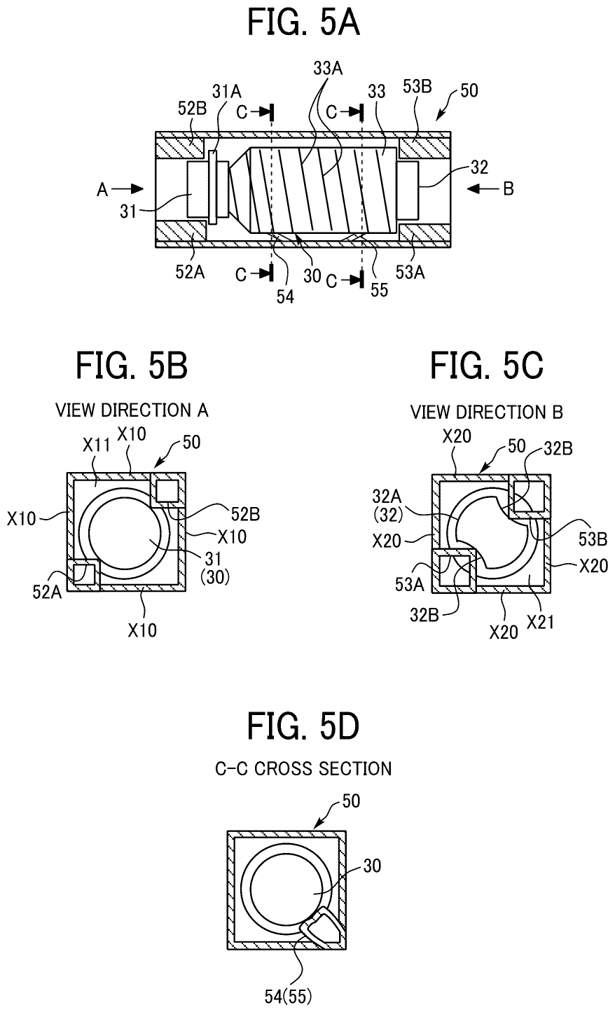

Specifically, the packing box 50 is formed in a square tube shape. The two holding portions 52A and 52B (first holding portions) at one end in the longitudinal direction (upper side in FIG. 4B) are formed at positions corresponding to the two edges M1 and M3 disposed at diagonal positions among the four edges M1 to M4 (see FIGS. 4B and 5B). On the other hand, the two holding portions 53A and 53B (second holding portions) at the other end in the longitudinal direction (lower side in FIG. 4B) are formed at positions corresponding to the two edges M1 and M3 (the same two edges as those at the one end) disposed at the diagonal positions among the four edges M1 to M4 (see FIGS. 4B and 5C).

In other words, when the packing box 50 having a square tube shape is projected in the longitudinal direction, the holding portions 52A and 52B at one end in the longitudinal direction and the holding portions 53A and 53B at the other end in the longitudinal direction are disposed at positions overlapping each other. In yet other words, the two holding portions 52A and 53A and the two holding portions 52B and 53B are respectively formed at positions corresponding to the two edges M1 and M3 disposed at the diagonal positions among the four edges M1 to M4. Alternatively, the two holding portions 53A and 53B at the other end may be formed at positions corresponding to two edges different from the two edges at which the two holding portions 52A and 52B at the one end are formed.

The slits 52A′, 52B′, 53A′, and 53B′ are formed in a direction substantially orthogonal to the creases M1′ to M4′ in the flat plate 50′ illustrated in FIG. 3, which is to be assembled into the packing box 50 as illustrated in FIGS. 4A and 4B. The slits 52A′, 52B′, 53A′, and 53B′ in the packing box 50 illustrated in FIG. 4A are made project inward to form the holding portions 52A, 52B, 53A, and 53B as illustrated in FIG. 4B.

In other words, the slits 52A′ and 53A′ are formed across the creases M1′ at positions away from the one end and the other end toward the center of the crease M1′ in the longitudinal direction, respectively, and the slits 52B′ and 53B′ are formed across the creases M3′ at positions away from the one end and the other end toward the center of the crease M3′ in the longitudinal direction, respectively. The portions between the slits 52A′, 52B′, 53A′, and 53B′ and the ends (i.e., the one end or the other end) are made project inward in the radial direction to form the multiple holding portions 52A, 52B, 53A, and 53B.

Specifically, the two slits 52A′ and 53A′ intersect the crease M1′, and the two slits 52B′ and 53B′ intersect the crease M3′ in the flat plate 50′ illustrated in FIG. 3. The flat plate 50′ is folded along the creases M1′ to M4′ to form a square tube as illustrated in FIG. 4A. In other words, the flat plate 50′ is assembled into the packing box 50 having the square tube. Then, portions between the slits 52A′, 52B′, 53A′, and 53B′ and the ends of the square tube in the longitudinal direction are pushed inward to form the four holding portions 52A, 52B, 53A, and 53B as illustrated in FIG. 4B and FIGS. 5A to 5C. As illustrated in FIGS. 5B and 5C, each of the four holding portions 52A, 52B, 53A, and 53B has a substantially L-shaped cross section.

To facilitate the operation of pushing the portions (to be the holding portions 52A, 52B, 53A, and 53B) between the slits and the ends in the longitudinal direction inward, for example, perforations, which are indicated by broken lines in FIG. 3, extending from the ends of the slits 52A′, 52B′, 53A′, and 53B′ may be formed. The slits 52A′, 52B′, 53A′, and 53B′ in the flat plate 50′ correspond to the ends of the holding portions 52A, 52B, 53A, and 53B in the longitudinal direction in the packing box 50.

The opposing faces of the flat face 51A and 51E at both ends among the five flat faces 51A to 51E in the flat plate 50′ illustrated in FIG. 3 are bonded and fixed to each other, for example, by an adhesive to form the packing box 50 having a square tube shape as illustrated in FIGS. 4A and 4B. In this case, a projection 51E1 of the flat face 51E at one end is used as a margin for applying the adhesive.

The method of fixing the flat faces 51A and 51E at both ends is not limited to adhesion. For example, a tongue-shape notch and a slit may be formed in the flat faces 51A and 51E at both ends, respectively, and the notch is fitted into the slit to fix the flat faces 51A and 51E at both ends. As illustrated in FIGS. 5A to 5C, the toner container 30 is firmly fixed and held in the packing box 50 by the four holding portions 52A, 52B, 53A, and 53B having the configuration as described above.

As illustrated in FIGS. 5A to 5C, the toner container 30 includes a bottle body 33 (i.e., a cylindrical body), a cap 31 that covers a head (a portion from which toner is discharged) of the bottle body 33, and a grip 32A disposed in a bottle bottom 32 of the bottle body 33. The bottle body 33 has a substantially cylindrical shape, and a projection 33A helically projecting toward the inside of the bottle body 33 is formed in the bottle body 33. The projection 33A moves toner in the bottle body 33 when the bottle body 33 is rotated in a predetermined direction to discharge the toner from an opening of the bottle body 33 to the image forming apparatus 1. The grip 32A has a diameter smaller than the outer diameter of the bottle body 33, and has recesses 32B which are parts of the outer circumference recessed inward as illustrated in FIG. 5C. The recesses 32B as gripping surfaces are held by hand to grip the toner container 30.

Thus, the toner container 30 is held in the packing box 50 with the cap 31 at one end in the longitudinal direction and the bottle bottom 32 at the other end in the longitudinal direction. At this time, the cap 31 is held by the first holding portions 52A and 52B, and the bottle bottom 32 is held by the second holding portions 53A and 53B.

As described above, the cap 31 and the bottle bottom 32 function as held portions held by the multiple holding portions 52A, 52B, 53A, and 53B. The diameter of the toner container 30 decreases from the central portion of the substantially cylindrical portion (i.e., the bottle body 33) to the cap 31 and the bottle bottom 32 in the longitudinal direction. Specifically, the portion of the cap 31 that functions as a first held portion has an outer diameter (circumference) smaller than the outer diameter (circumference) of the central portion of the bottle body 33 in the longitudinal direction and is held by the first holding portions 52A and 52B. As illustrated in FIG. 5A, the first holding portions 52A and 52B are positioned outside a projection 31A (e.g., a flange) of the cap 31 in the longitudinal direction in the packing box 50, and project further inward than the outer circumference of the projection 31A in the radial direction. As illustrated in FIG. 5B, the first holding portions 52A and 52B are arranged on a diagonal line of the square tube. The edges of the first holding portions 52A and 52B contact the outer circumferential surface of the cap 31.

The bottle bottom 32 that functions as a second held portion has an outer diameter (circumference) smaller than the outer diameter (circumference) of the central portion of the bottle body 33 in the longitudinal direction. Parts of the outer circumference of the bottle bottom 32 are recessed inward to form the recesses 32B of the grip 32A which are held by the second holding portions 53A and 53B. As illustrated in FIG. 5C, the second holding portions 53A and 53B project further inward than the outer circumference of the bottle body 33 in the radial direction. The edges of the second holding portions 53A and 53B preferably face the recesses 32B (gripping surfaces). The edges of the second holding portions 53A and 53B may contact the recesses 32B or may face the recesses 32B with a gap.

As illustrated in FIGS. 5B and 5C, the first holding portion 52A and the second holding portion 53A are positioned at positions corresponding to one vertex of a rim X10 on one edge (i.e., the edge M1 in FIG. 4B) extending in the longitudinal direction and the corresponding vertex of a rim X20 on the one edge (i.e., the edge M1) among four vertexes of each of the rim X10 and the rim X20, respectively, and the first holding portion 52B and the second holding portion 53B are positioned at positions corresponding to another vertex of the rim X10 on another edge (i.e., the edge M3 in FIG. 4B) extending in the longitudinal direction and the corresponding vertex of the rim X20 on the edge (i.e., the edge M3) among the four vertexes of each of the rim X10 and the rim X20, respectively.

As described above, the flat plate 50′ is folded along the creases M1′ to M4′ to form a square tube having the edges M1 to M4 corresponding to the creases M1′ to M4′, and then the multiple slits 52A′, 52B′, 53A′, and 53B′ are pushed inward to function as the holding portions 52A, 52B, 53A, and 53B. Thus, the flat plate 50′ is assembled into the packing box 50.

As a result, the toner container 30 can be firmly fixed and held, for example, without a cushioning material for filling the gap between the toner container 30 and the packing box 50, with a relatively simple configuration, without increasing the cost and complexity, and without reducing the ease of taking out the toner container 30 from the packing box 50. Accordingly, the toner container 30 does not jump out of the packing box 50 during transportation from the manufacturing factory to the transportation destination (delivery destination), and the toner container 30 is unlikely to move around in the packing box 50 due to vibration during transportation. Thus, the tone container 30 is unlikely to be vibrated in the packing box 50, and the air existing between the toner particles is unlikely to be released by the vibration. As a result, the toner accommodated in the toner container 30 is unlikely to be compacted, and the toner is unlikely to be aggregated and solidified when the toner is left in the compacted state for a long time.

In particular, each of the multiple holding portions 52A, 52B, 53A, and 53B is formed in a substantially L-shape across the edge M1 or M3, and a root on one side and a root on the other side of each of the multiple holding portions 52A, 52B, 53A, and 53B are connected to adjacent flat faces. Specifically, each of the holding portions 52A and 53A disposed across the edge M1 has a root on one side connected to the first flat face 51A and a root on the other side connected to the second flat surface 51B. Such a configuration can increase the mechanical strength of the holding portions 52A, 52B, 53A, and 53B.

With reference to FIGS. 3 and FIGS. 4A and 4B, in the packing box 50, the end portions X1 and X2 have the rims X10 and X20 defining (surrounding) openings X11 and X21, respectively (i.e., perimeters of the openings X11 and X21). The rims X10 and X20 are polygonal rims connecting adjacent vertexes of the multiple edges M1 to M4 in the end portion X1 and the end portion X2 in the longitudinal direction, respectively. The toner container 30 is inserted into and taken out from the packing box 50 through the opening X11 or the opening X21. In other words, the packing box 50 is flapless (lidless) at both ends in the longitudinal direction.

The rim X10 of the end portion X1 does not entirely contact an imaginary plane S1 orthogonal to the longitudinal direction, and the rim X20 of the end portion X2 does not entirely contact an imaginary plane S2 orthogonal to the longitudinal direction. In other words, part of the rim X10 contacts the imaginary plane S1, and part of the rim X20 contacts the imaginary plane S2. In yet other words, each of the rim X10 and the rim X20 has a shifted part in at least a part of the rim X10 or X20 at both ends of the polygonal tube, the shifted part is shifted from the imaginary plane S1 or S2 orthogonal to the longitudinal direction, and a limited part of the shifted part of each of the rims X10 and X20 contacts the corresponding imaginary plane S1 or S2. As illustrated in FIG. 3, in the flat plate 50′ to be assembled into the packing box 50, ridgelines X10′ and X20′ of the end portions X1 and X2 in the longitudinal direction are not on straight lines corresponding to the imaginary planes S1 and S2, respectively. Specifically, part or all of the rims X10 and X20 of the end portions X1 and X2 (i.e., an inclined part) are respectively inclined with respect to the imaginary planes S1 and S2, which are the straight lines in FIG. 3.

Accordingly, as illustrated in FIGS. 4A and 4B, when the packing box 50 is placed vertically with the end portion X2, which is the bottom portion in FIGS. 4A and 4B, in contact with the imaginary plane S2 as the ground surface, the end portion X2 does not evenly contact the imaginary plane S2 (the ground surface) in a well-balanced manner, but unevenly contacts the imaginary plane S2. The same applies to the relationship between the other end portion X1 and the imaginary plane S1. Accordingly, the packing box 50 that packs the toner containers 30 can be placed horizontally with one of the flat faces 51A to 51E in contact with the ground surface, but is difficult to place vertically with one of the end portions X1 and X2 in contact with the ground surface.

As described above, it is difficult to vertically place the packing box 50 in the longitudinal direction. In other words, the packing box 50 is unlikely to stand by itself. Accordingly, the packing box 50 is horizontally placed with one of the flat faces 51A to 51E extending in the longitudinal direction grounded. With such a configuration, the packing box 50 is not freestanding in the longitudinal direction, and thus does not fall down accidentally. As a result, the toner container 30 (packed object) does not receive a large impact due to the falling down.

If the packing box 50 is placed vertically, the toner container 30 packed in the packing box 50 is vertically placed in the longitudinal direction for a long time, and the toner stored in the toner container 30 may be accumulated, aggregated, and solidified in the lower portion. In such a case, when the toner container 30 is taken out from the packing box 50 and used in the image forming apparatus 1, the toner may not be discharged smoothly from a toner discharge port formed on the cap 31, or an abnormal image such as a white stripe or a white spot due to the toner aggregation may occur. In contrast, when the packing box 50 (toner container 30) is not freestanding and is not placed vertically, the toner in the toner container 30 is unlikely to be unevenly accumulated on one side in the longitudinal direction. As a result, the toner is unlikely to be aggregated in the toner container 30. Further, since the toner container 30 is unlikely to receive a large impact, the toner does not leak to the outside from a joint of the cap 31 of the toner container 30.

With reference to FIGS. 3, 5A, and 5C, the packing box 50 has fixing portions 54 and 55 projecting inward to fix the toner container 30 (packed body) such that the toner container 30 does not rotate about the center axis of the toner container 30 extending in the longitudinal direction. The fixing portions 54 and 55 are disposed between the first holding portions 52A and 52B (holding portions) formed at one end in the longitudinal direction and the second holding portions 53A and 53B (holding portions) formed at the other end in the longitudinal direction.

More specifically, as illustrated in FIG. 3, the flat plate 50′ has two slits 54′ and 55′ functioning as the fixing portions in the packing box 50 in addition to the multiple slits 52A′, 52B′, 53A′, and 53B′ functioning as the holding portions in the packing box 50. The two slits 54′ and 55′ are formed across the second crease M2′ (i.e., a crease different from the creases M1′ and M3′ where the holding portions 52A, 52B, 53A, and 53B are formed). When the flat plate 50′ is assembled into the packing box 50, these slits 54′ and 55′ are bent so as to project inward similarly to the four slits 52A′, 52B′, 53A′, and 53B′ functioning as the holding portions 52A, 52B, 53A, and 53B. The slits 54′ and 55′ are bent after the toner container 30 is inserted into the packing box 50. The toner container 30 (bottle body 33) has a helical projection on the circumferential surface, and the ends of the fixing portions 54 and 55 fits into (contacts) the circumferential surface of the toner container 30. The fixing portions 54 and 55 are formed by bending the slits 54′ and 55′.

As illustrated in FIGS. 4A and 4B, the slits 54′ and 55′ (i.e., the fixing portions 54 and 55) are disposed at positions on the edge M2 where the holding portions 52A, 52B, 53A, and 53B are not formed among the edges M1 to M4 of the packing box 50. Thus, the toner container 30 held by the holding portions 52A, 52B, 53A, and 53B is fixed by the fixing portions 54 and 55 in the packing box 50 so as not to rotate.

Thus, the toner container 30 can be firmly fixed and held in the packing box 50 without rotating. Accordingly, the toner container 30 does not rotate and move around in the packing box 50 due to vibration during transportation from the manufacturing factory to the destination (delivery destination). Further, the ends of the slits 54′ and 55′ are bent in directions away from each other to contact the circumferential surface of the toner container 30, and thus the toner container 30 is prevented from moving in the longitudinal direction (see FIG. 5A).

With reference to FIGS. 5A to 5D, the toner container 30 (packed object) is held without contacting any portion other than the holding portions 52A, 52B, 53A, and 53B and the fixing portions 54 and 55 in the packing box 50. In other words, the toner container 30 floats in the air in the packing box 50 except for the portions held by the holding portions 52A, 52B, 53A, and 53B and the fixing portions 54 and 55, and there is a large space between the packing box 50 and the toner container 30. With such a configuration, even if the packing box 50 vibrates during transportation or an unexpected external force is applied to the packing box 50, the vibration or the external force is unlikely to propagate to the toner container 30. Accordingly, the effects described above can be achieved.

For example, with reference to FIGS. 5A to 5D, the holding portions 52A, 52B, 53A, and 53B restrict the toner container 30 (packed object) from moving in the longitudinal direction (the left-right direction in FIG. 5A). In other words, the toner container 30 is sandwiched between the first holding portions 52A and 52B and the second holding portions 53A and 53B so as not to largely move in the longitudinal direction in the packing box 50. Such a configuration can achieve the effects described above.

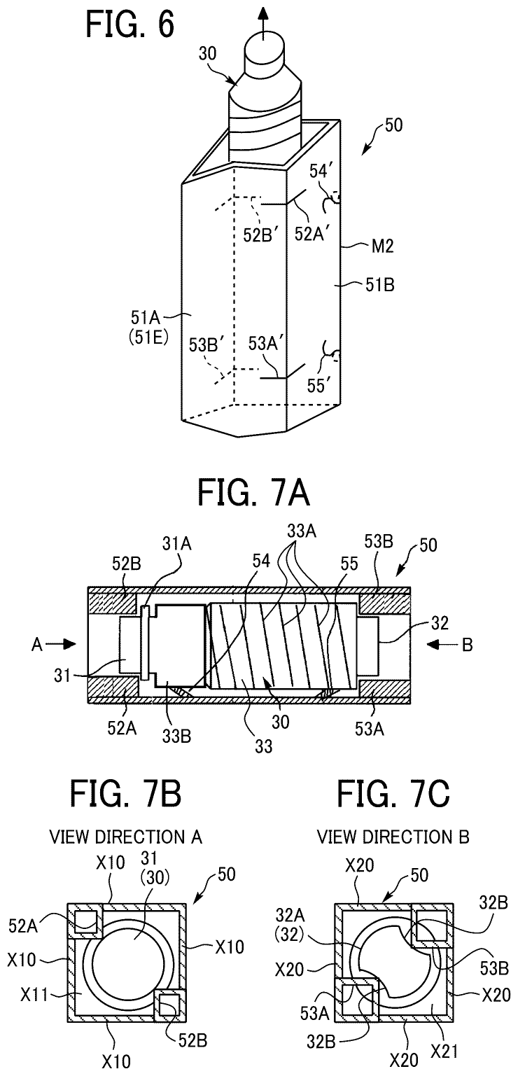

With reference to FIG. 6, the holding portions 52A and 52B at one end or the holding portions 53A and 53B at the other end in the longitudinal direction (i.e., at least two holding portions) are pulled out toward the outside of the square tube in the radial direction to allow the toner container 30 (packed object) to be taken out from the packing box 50.

Specifically, in the packing box 50 packing the toner container 30 as illustrated in FIG. 2 and FIGS. 5A to 5D, when the first holding portions 52A and 52B, the second holding portions 53A and 53B, and the fixing portions 54 and 55 folded inward are folded back (pulled) outward as illustrated in FIG. 6, the packing box 50 does not restrict the toner container 30 from moving in the longitudinal direction of the packing box 50. Accordingly, the toner container 30 can be taken out in the direction indicated by the arrow in FIG. 6 from one end in the longitudinal direction (e.g., the end at which the first holding portions 52A and 52B are disposed). When the toner container 30 is inserted into the empty packing box 50, the operation opposite to the above-described operation to take out the toner container 30 is performed.

With reference to FIGS. 5A to 5D, for example, the multiple holding portions 52A, 52B, 53A, and 53B (the slits 52A′, 52B′, 53A′, and 53B′) are formed at positions away from the rim X10 at one end or the rim X20 at the other end in the longitudinal direction toward the center in the longitudinal direction. As illustrated in FIG. 5A, the toner container 30 (packed object) is held in the packing box 50 so as not to protrude from both the openings X11 and X21 in the longitudinal direction.

With such a configuration, as compared with the holding portions 52A, 52B, 53A, and 53B formed in the vicinity of the rims X10 and X20 in the longitudinal direction, the packing performance of the packing box 50 to pack the toner container 30 is enhanced, and foreign substances entering the inside from the openings X11 and X21 at both ends are less likely to adhere to the toner container 30. Further, the mechanical strength of the holding portions 52A, 52B, 53A, and 53B can be increased as compared with the holding portions 52A, 52B, 53A, and 53B formed in the vicinity of the rims X10 and X20 in the longitudinal direction.

### First Modification

As illustrated in FIG. 7, in a first modification, a toner container 30 packed in a packing box 50 includes a bottle holder 33B attached to the head of the bottle body 33. The bottle holder 33B has an opening and a shutter for opening and closing the opening. When the shutter is opened, toner can be discharged from the opening of the bottle body 33 to the image forming apparatus 1. The bottle holder 33B includes a gear that meshes with a gear of the image forming apparatus 1 to rotate the bottle body 33 in a predetermined direction.

The cap 31 covers the shutter of the bottle holder 33B disposed at the head of the bottle body 33 to prevent the shutter from being opened. Accordingly, the shutter is not opened by the accidental contact with the shutter or an impact applied to the toner container 30 to prevent the toner in the bottle body 33 from being discharged. The cap 31 has the projection 31A having an outer circumference larger than that of the front end of the cap 31. As illustrated in FIG. 7A, the first holding portions 52A and 52B are positioned outside the projection 31A of the cap 31 in the longitudinal direction in the packing box 50, and project further inward than the outer circumference of the projection 31A in the radial direction. As illustrated in FIG. 7B, the first holding portions 52A and 52B are arranged on a diagonal line. The edges of the first holding portions 52A and 52B may contact the outer circumferential surface of the cap 31 or may face the outer circumferential surface of the cap 31 with a gap.

The bottle bottom 32 that functions as the second held portion has an outer diameter (circumference) smaller than the outer diameter (circumference) of the central portion of the bottle body 33 in the longitudinal direction. Parts of the outer circumference of the bottle bottom 32 are recessed inward to form the recesses 32B of the grip 32A which are held by the second holding portions 53A and 53B. As illustrated in FIG. 7C, the second holding portions 53A and 53B project further inward than the outer circumference of the bottle body 33 in the radial direction. The edges of the second holding portions 53A and 53B may contact the recesses 32B or may face the recesses 32B with a gap.

As illustrated in FIGS. 7B and 7C, the first holding portions 52A and 52B and the second holding portions 53A and 53B may be disposed on different edges among the four edges M1 to M4 connected to the rims X10 and X20. In the packing box 50 according to the first modification, one of the fixing portions 54 and 55 contacts the bottle holder 33B and the other of the fixing portions 54 and 55 contacts the bottle body 33.

The packing box 50 according to the first modification has the end portions X1 and X2 that prevent the packing box 50 from being freestanding (vertically placed) in the longitudinal direction. Accordingly, the toner container 30 packed in the packing box 50 can be sufficiently fixed without increasing the cost and complexity of the packing box 50 and without reducing the ease of taking out the toner container 30 (packed object) from the packing box 50, and the packing box 50 is unlikely to stand by itself in the longitudinal direction.

### Second Modification

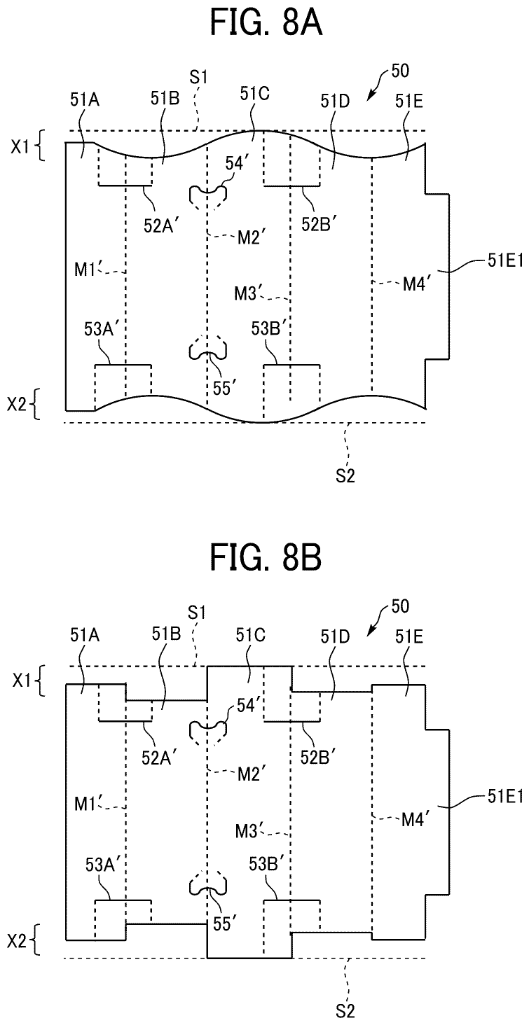

With reference to FIG. 8, a packing box 50 according to a second modification has the holding portions 52A, 52B, 53A, and 53B that holds the toner container 30, and the end portions X1 and X2 that prevent the packing box 50 from being freestanding (vertically placed) in the longitudinal direction, similarly to the case illustrated in FIG. 3. In particular, the rim X10 of the end portion X1 does not entirely contact the imaginary plane S1 orthogonal to the longitudinal direction, and the rim X20 of the end portion X2 does not entirely contact the imaginary plane S2 orthogonal to the longitudinal direction. In other words, part of the rim X10 contacts the imaginary plane S1, and part of the rim X20 contacts the imaginary plane S2.

In FIG. 3, part or all of the rims X10 and X20 of the end portions X1 and X2 are respectively inclined with respect to the imaginary planes S1 and S2, which are the straight lines. However, in FIG. 8A, part or all of the rims X10 and X20 (the ridgelines X10′ and X20′) of the end portions X1 and X2 (i.e., a curved part) are curved (are not straight) with respect to the imaginary plane S1 and S2, respectively, unlike the rims X10 and X20 illustrated in FIG. 3. In FIG. 8B, the rims X10 and X20 (the ridgelines X10′ and X20′) of the end portions X1 and X2 (i.e., a stepped part) have a stepped shape.

With the end portions X1 and X2 which are curved or have such a stepped shape, the toner container 30 packed in the packing box 50 can be sufficiently fixed without increasing the cost and complexity of the packing box 50 and without reducing the ease of taking out the toner container 30 (packed object) from the packing box 50, and the packing box 50 is unlikely to stand by itself in the longitudinal direction.

### Third Modification

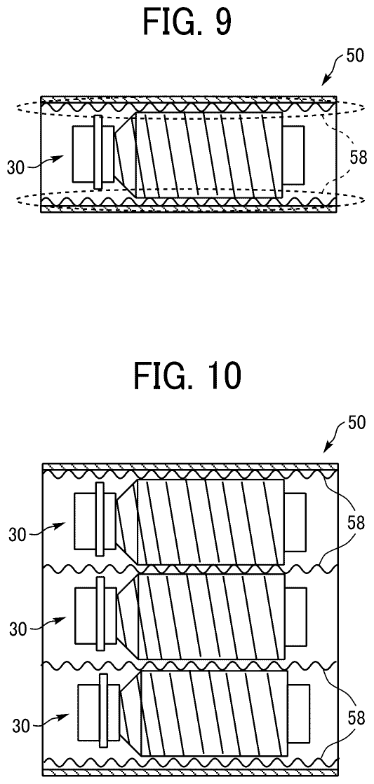

A packing box 50 according to a third modification illustrated in FIG. 9 has the holding portions 52A, 52B, 53A, and 53B that holds the toner container 30, and the end portions X1 and X2 that prevent the packing box 50 from being freestanding (vertically placed) in the longitudinal direction, similarly to the case illustrated in FIG. 3. The illustrations of the holding portions 52A, 52B, 53A, and 53B are omitted in FIG. 9. As illustrated in FIG. 9, in the packing box 50 according to the third modification, at least an inner wall face 58 that contacts the toner container 30 (packed object) is corrugated in the longitudinal direction.

Unlike the packing box 50 illustrated in FIGS. 5A to 5D, the toner container 30 does not float in the air in the packing box 50 according to the third modification and contacts portions other than the portions held by the holding portions 52A, 52B, 53A, and 53B and the fixing portions 54 and 55. Specifically, the packing box 50 according to the third modification has a contact portion (i.e., the inner wall face 58) in contact with the toner container 30 in addition to the holding portions 52A, 52B, 53A, and 53B and the fixing portions 54 and 55. The contact portion is corrugated, including a case where a separated wave-shaped component is attached to the inner wall face as a cushioning material. The corrugated inner wall face 58 is not corrugated in a direction intersecting the longitudinal direction, but is corrugated in the longitudinal direction so that the contact portion (i.e., the inner wall face 58) is in point-contact with the toner container 30.

With such a configuration, even if the packing box 50 vibrates during transportation or an unexpected external force is applied to the packing box 50, the vibration or the external force is unlikely to propagate to the toner container 30 (the vibration or the external force weakened by the wave-shaped inner wall face 58 may propagate to the toner container 30). Accordingly, the above-described situation caused by vibration is prevented.

### Fourth Modification

A packing box 50 according to a fourth modification illustrated in FIG. 10 has the holding portions 52A, 52B, 53A, and 53B that holds the toner container 30, and the end portions X1 and X2 that prevent the packing box 50 from being freestanding (vertically placed) in the longitudinal direction, similarly to the case illustrated in FIG. 3. The illustrations of the holding portions 52A, 52B, 53A, and 53B are omitted in FIG. 10.

As illustrated in FIG. 10, the packing box 50 according to the fourth modification can pack (accommodate) multiple toner containers 30 (three toner containers 30 in FIG. 10) in parallel. The packing box 50 has the holding portions 52A, 52B, 53A, and 53B for holding the respective toner containers 30. Corrugated inner wall faces 58 as cushioning materials are disposed between the adjacent toner containers 30. In other words, the packing box 50 has the inner wall faces 58 corrugated in the longitudinal direction to contact at least the multiple toner containers 30, respectively.

With such a configuration, even if the packing box 50 vibrates during transportation or an unexpected external force is applied to the packing box 50, the vibration or the external force is unlikely to propagate to the multiple toner containers 30 (the vibration or the external force weakened by the wave-shaped inner wall face 58 may propagate to the multiple toner containers 30). Accordingly, the above-described situation caused by vibration is prevented.

As described above, the packing box 50 has a polygonal tube shape (e.g., a square tube shape) to pack the toner container 30 (packed object) therein and has the edges M1 to M4 folded along the creases M1′ to M4′ in the flat plate 50′. The packing box 50 extends in the longitudinal direction. The packing box 50 has holding portions 52A, 52B, 53A, and 53B formed at positions corresponding to at least the two edges M1 and M3 among the multiple edges M1 to M4 at one end in the longitudinal direction and at least the two edges M1 and M3 among the multiple edges M1 to M4 at the other end in the longitudinal direction. Each of the holding portions 52A, 52B, 53A, and 53B projects inward in the radial direction orthogonal to the longitudinal direction to hold the toner container 30 (packed object). Further, the packing box 50 has end portions X1 and X2 that prevent the packing box 50 from being freestanding in the longitudinal direction at both ends in the longitudinal direction, respectively.

Accordingly, the toner container 30 packed in the packing box 50 can be sufficiently fixed without increasing the cost and complexity of the packing box 50 and without reducing the ease of taking out the toner container 30 (packed object) from the packing box 50, and the packing box 50 is unlikely to stand by itself in the longitudinal direction.

As described above, the packing box 50 packs the toner container 30, which is detachably attached to the image forming apparatus 1, as a packed object to be packed in the packing box 50. However, the object to be packed in the packing box 50 is not limited to the toner container 30, and the packing box can be used to pack a developing device containing a developer therein as a packed object, or to pack a process cartridge including an image forming unit, such as a developing device and a photoconductor drum integrated in a single unit, as a packed object. Further, the packing box can be used to pack not only a separate packed object (unit) detachably attached to the image forming apparatus but also a packed object unrelated to the image forming apparatus.

As described above, the packing box 50 has a square tube shape but may have a polygonal tube shape other than the square tube shape. As described above, the first holding portions 52A and 52B (holding portions at one end in the longitudinal direction) and the second holding portions 53A and 53B (holding portions at the other end in the longitudinal direction) are formed on the same edges M1 and M3, respectively. Alternatively, the first holding portions 52A and 52B may be formed on edges different from edges on which the second holding portions 53A and 53B are formed. For example, the first holding portions 52A and 52B (holding portions at one end in the longitudinal direction) are formed on the two edges M1 and M3, and the second holding portions 53A and 53B (holding portions at the other end in the longitudinal direction) are formed on the two edges M2 and M4. With such a configuration, effects similar to those described above are also achieved.

The present disclosure is not limited to the above-described embodiment, modifications, and variations, and the configuration of the present embodiment can be appropriately modified other than suggested in the above embodiment, modifications, and variations within a scope of the technological concept of the present disclosure. The number, position, and shape of the components described above are not limited to those embodiments described above. Desirable number, position, and shape can be determined to perform the present disclosure.

The present disclosure may be applicable to, for example, a combination of the following aspects 1 to 13.

### Aspect 1

A packing box is a polygonal tube-shaped packing box to pack a packed object therein. The polygonal tube shape having multiple edges is formed by folding a flat plate along creases put on the flat plate. The packing box has holding portions and end portions. When a direction in which the polygonal tube shape extends is defined as a longitudinal direction, the holding portions that project inward to hold the packed object are formed at positions corresponding to two edges of the multiple edges at one end in the longitudinal direction and two edges of the multiple edges at the other end in the longitudinal direction, respectively. The end portions are formed at both ends in the longitudinal direction, respectively, so as not to make the packing box stand by itself in the longitudinal direction.

In other words, a packing box includes a polygonal tube extending in a longitudinal direction. The polygonal tube is assembled from a flat plate folded along multiple creases in the longitudinal direction to form multiple edges to pack an object in the polygonal tube. The polygonal tube has holding portions and polygonal rims. The holding portions hold the object. The holding portions project inward in a radial direction orthogonal to the longitudinal direction from positions corresponding to two of the multiple edges at one end of the polygonal tube in the longitudinal direction and two of the multiple edges at another end of the polygonal tube in the longitudinal direction. The polygonal rims have a shifted part in at least a part of the polygonal rims at both ends of the polygonal tube. The shifted part is shifted from an imaginary plane orthogonal to the longitudinal direction.

### Aspect 2

In the packing box according to Aspect 1, the end portion has a rim and an opening surrounded by the rim. The rim is a perimeter of the opening formed by connecting adjacent vertexes of the multiple edges at an end in the longitudinal direction. The rim is formed so as not to entirely contact one imaginary plane orthogonal to the longitudinal direction.

In other words, the polygonal rims surround openings at both ends of the polygonal tube in the longitudinal direction, respectively. A limited part of the shifted part of each of the polygonal rims contacts the imaginary plane.

### Aspect 3

In the packing box according to Aspect 2, part or all of the rim is inclined with respect to the imaginary plane.

In other words, the shifted part has an inclined part inclined with respect to the imaginary plane.

### Aspect 4

In the packing box according to Aspect 2 or 3, the rim is partially or entirely curved. In other words, the shifted part has a curved part curved with respect to the imaginary plane.

### Aspect 5

In the packing box according to any one of Aspects 2 to 4, the rim is formed in a stepped shape.

In other words, the shifted part has a stepped part.

### Aspect 6

In the packing box according to any one of Aspects 1 to 5, a fixing portion that projects inward to fix the packed object so as not to rotate around the longitudinal direction is formed between the holding portions formed at the one end in the longitudinal direction and the holding portions formed at the other end in the longitudinal direction.

In other words, the polygonal tube further has a fixing portion projecting inward in the radial direction between the holding portions at the one end and said another end in the longitudinal direction to fix the object.

### Aspect 7

In the packing box according to any one of Aspects 1 to 6, an inner wall face that contacts the packed object is corrugated in at least the longitudinal direction.

In other words, the polygonal tube further has an inner wall face corrugated in the longitudinal direction to contact the object.

### Aspect 8

In the packing box according to any one of Aspects 1 to 7, the holding portions restrict the movement of the packed object in the longitudinal direction. The packed object can be taken out by pulling out at least two of the holding portions at the one end or the other end in the longitudinal direction toward the outside of the polygonal tube.

In other words, the holding portions projecting inward in the radial direction restrict the object from moving in the longitudinal direction, and at least two of the holding portions at the one end or said another end are pulled outward in the radial direction.

### Aspect 9

In the packing box according to any one of Aspects 1 to 8, each of the multiple holding portions is formed by inwardly projecting a portion from a slit formed across the edge at a position away from an end at the one end or the other end in the longitudinal direction toward a center side in the longitudinal direction to the end.

In other words, the polygonal tube further has slits disposed across the multiple edges at positions away from the polygonal rims toward a center of the polygonal tube in the longitudinal direction. Portions between the slits and the polygonal rims are made project inward in the radial direction to form the holding portions, respectively.

### Aspect 10

In the packing box according to any one of Aspects 1 to 10, the packed object is a toner container that stores toner therein.

In other words, the polygonal tube packs the object including a toner container storing toner.

### Aspect 11

A packing box is a polygonal tube-shaped packing box to pack a packed object therein. The polygonal tube shape having multiple edges is formed by folding a flat plate along creases put on the flat plate. When a direction in which the polygonal tube shape extends is defined as a longitudinal direction, an inner wall face that contacts at least the packed object is corrugated in the longitudinal direction.

In other words, a packing box includes a polygonal tube extending in a longitudinal direction. The polygonal tube is assembled from a flat plate folded along multiple creases in the longitudinal direction to form multiple edges to pack an object in the polygonal tube. The polygonal tube has an inner wall face corrugated in the longitudinal direction to contact the object.

### Aspect 12

A toner container as the packed object is accommodated in the packing box according to any one of Aspects 1 to 11. The toner container is formed in a substantially cylindrical shape. A held portion of the toner container held by the multiple holding portions is formed so as to be recessed from an outer circumference of a portion having the substantially cylindrical shape located on a center side in the longitudinal direction from the held portion.

In other words, A toner container includes a cylindrical body and held portions. The cylindrical body extends in the longitudinal direction to be packed in the packing box according to any one of Aspects 1 to 11. The cylindrical body stores toner. The held portions are disposed at both ends of the cylindrical body to be held by the holding portions. Each of the held portions having a smaller outer circumference than the cylindrical body.

### Aspect 13

The toner container according to Aspect 12, further includes a cap covering a head of the cylindrical body from which the toner is discharged. One of the held portions is disposed on an outer circumferential face of the cap.

Aspect 14 In the toner container according to Aspect 13, the cylindrical body has a bottom portion opposite the head in the longitudinal direction. Another of the held portions is disposed on an outer circumferential face of the bottom portion. Said another of the held portions is recessed from the outer circumferential face of the bottom portion in the radial direction.

### Aspect 15

A method of assembling a packing box that pack a packed object therein, includes a step to form edges by folding a flat plate along creases put on the flat plate to form a polygonal tube shape and a step to make portions from slits to ends in a longitudinal direction project inward to form holding portions that hold the packed object, when a direction in which the creases extend is defined as the longitudinal direction. The slits are formed in a direction substantially orthogonal to the creases of the flat plate. The holding portions are formed at positions corresponding to two of the multiple edges at one end in the longitudinal direction and two of the multiple edges at the other end in the longitudinal direction. End portions are formed at both ends in the longitudinal direction, respectively, so as not to make the packing box stand by itself in the longitudinal direction.

In other words, a method of assembling a packing box, includes folding a flat plate along multiple creases to form multiple edges to form a polygonal tube extending in a longitudinal direction to pack an object in the polygonal tube. The flat plate has multiple creases, slits, and ridgelines. The multiple creases extend in the longitudinal direction. The slits extend across the multiple creases in a direction orthogonal to the multiple creases. The ridgelines at both ends of the flat plate in the longitudinal direction to be polygonal rims of the polygonal tube. The polygonal tube has the multiple edges and the polygonal rims. The multiple edges respectively correspond to the multiple creases. The polygonal rims surround openings at both ends of the polygonal tube in the longitudinal direction, respectively, and have a shifted part in at least a part of the polygonal rims at both ends of the polygonal tube. The shifted part is shifted from an imaginary plane orthogonal to the longitudinal direction. The method further includes making portions between the slits and the polygonal rims in the longitudinal direction project inward in a radial direction orthogonal to the longitudinal direction to form holding portions that hold the object, at positions corresponding to two of the multiple edges at one end in the longitudinal direction and two of the multiple edges at another end in the longitudinal direction.

As described above, according to one aspect of the present disclosure, a packing box, a toner container, and a method of assembling the packing box can be provided without increasing the cost and complexity of the packing box. The packing box can sufficiently fix a packed object packed in the packing box without reducing the ease of taking out the packed object from the packing box. Further, the packing box is difficult to be freestanding in the longitudinal direction.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A packing box comprising:
a polygonal tube extending in a longitudinal direction, the polygonal tube assembled from a flat plate folded along multiple creases in the longitudinal direction to form multiple edges to pack an object in the polygonal tube, the polygonal tube having:
holding portions to hold the object, the holding portions projecting inward in a radial direction orthogonal to the longitudinal direction from positions corresponding to:
two of the multiple edges at one end of the polygonal tube in the longitudinal direction; and
two of the multiple edges at another end of the polygonal tube in the longitudinal direction; and
polygonal rims having a shifted part in at least a part of the polygonal rims at both ends of the polygonal tube, the shifted part shifted from an imaginary plane orthogonal to the longitudinal direction.

2. The packing box according to claim 1,
wherein the polygonal rims surround openings at both ends of the polygonal tube in the longitudinal direction, respectively, and
a limited part of the shifted part of each of the polygonal rims contacts the imaginary plane.

3. The packing box according to claim 2,
wherein the shifted part has an inclined part inclined with respect to the imaginary plane.

4. The packing box according to claim 2,
wherein the shifted part has a curved part curved with respect to the imaginary plane.

5. The packing box according to claim 2,
wherein the shifted part has a stepped part.

6. The packing box according to claim 1,
wherein the polygonal tube further has a fixing portion projecting inward in the radial direction between the holding portions at the one end and said another end in the longitudinal direction to fix the object.

7. The packing box according to claim 1,
wherein the polygonal tube further has an inner wall face corrugated in the longitudinal direction to contact the object.

8. The packing box according to claim 1,
wherein the holding portions projecting inward in the radial direction restrict the object from moving in the longitudinal direction, and
at least two of the holding portions at the one end or said another end are pulled outward in the radial direction.

9. The packing box according to claim 1,
wherein the polygonal tube further has slits disposed across the multiple edges at positions away from the polygonal rims toward a center of the polygonal tube in the longitudinal direction, and
portions between the slits and the polygonal rims are made project inward in the radial direction to form the holding portions, respectively.

10. The packing box according to claim 1,
wherein the polygonal tube packs the object including a toner container storing toner.

11. A packing box comprising:
a polygonal tube extending in a longitudinal direction,
the polygonal tube assembled from a flat plate folded along multiple creases in the longitudinal direction to form multiple edges to pack an object in the polygonal tube, and
the polygonal tube having an inner wall face corrugated in the longitudinal direction to contact the object.

12. A toner container comprising:
a cylindrical body extending in the longitudinal direction to be packed in the packing box according to claim 1, the cylindrical body to store toner; and
held portions at both ends of the cylindrical body to be held by the holding portions, each of the held portions having a smaller outer circumference than the cylindrical body.

13. The toner container according to claim 12, further comprising a cap covering a head of the cylindrical body from which the toner is discharged,
wherein one of the held portions is disposed on an outer circumferential face of the cap.

14. The toner container according to claim 13,
wherein the cylindrical body has a bottom portion opposite the head in the longitudinal direction,
another of the held portions is disposed on an outer circumferential face of the bottom portion, and
said another of the held portions is recessed from the outer circumferential face of the bottom portion in the radial direction.

15. A method of assembling a packing box, comprising:
folding a flat plate along multiple creases to form multiple edges to form a polygonal tube extending in a longitudinal direction to pack an object in the polygonal tube,
the flat plate having:
the multiple creases extending in the longitudinal direction;
slits extending across the multiple creases in a direction orthogonal to the multiple creases; and
ridgelines at both ends of the flat plate in the longitudinal direction to be polygonal rims of the polygonal tube, and
the polygonal tube having:
the multiple edges respectively corresponding to the multiple creases; and
the polygonal rims:
surround openings at both ends of the polygonal tube in the longitudinal direction, respectively; and
have a shifted part in at least a part of the polygonal rims at both ends of the polygonal tube, the shifted part shifted from an imaginary plane orthogonal to the longitudinal direction; and
making portions between the slits and the polygonal rims in the longitudinal direction project inward in a radial direction orthogonal to the longitudinal direction to form holding portions that hold the object, at positions corresponding to:
two of the multiple edges at one end in the longitudinal direction; and
two of the multiple edges at another end in the longitudinal direction.
